(19) United States
(12) Patent Application Publication
(10) Pub. No.: US 2026/0253380 A1
(43) Pub. Date: Aug. 27, 2026

(54) INFORMATION PROCESSING SYSTEM, INFORMATION PROCESSING METHOD, AND NON-TRANSITORY RECORDING MEDIUM

(71) Applicant: NEC Corporation, Minato-ku, Tokyo (JP)

(72) Inventors: Muneyuki YOSHIKAWA, Tokyo (JP); Osamu SAISHO, Tokyo (JP); Yusuke INUTSUKA, Tokyo (JP); Yoshihiro NAKATANI, Tokyo (JP); Yuki SHIMIZU, Tokyo (JP)

(73) Assignee: NEC Corporation, Minato-ku, Tokyo (JP)

(21) Appl. No.: 18/875,779

(22) PCT Filed: Jun. 27, 2022
(86) PCT No.: PCT/JP2022/025584

§ 371 Date: Dec. 17, 2024

(51) Int. Cl. G06V 10/764; G06V 10/74; G06V 10/98; G06V 40/16; G06V 40/40

(52) U.S. Cl. CPC G06V 10/764; G06V 10/761; G06V 10/993; G06V 40/172; G06V 40/45

(57) ABSTRACT

An information processing system includes: an information acquisition unit that acquires authentication history information indicating a history of authentication processing of collating/verifying a target image with a registered image; an abnormality detection unit that detects an abnormality in the authentication processing, based on the authentication history information; a cause classification unit that classifies a cause of the abnormality by using the authentication history information in response to the abnormality being detected; and a cause notification unit that gives notice of the classified cause of the abnormality. According to such an information processing system, it is possible to properly give notice of the cause in response to the abnormality occurring in the authentication processing.

### TECHNICAL FIELD

This disclosure relates to technical fields of an information processing system, an information processing method, and a recording medium.

### BACKGROUND ART

A known system of this type detects an abnormality in authentication processing (e.g., a situation in which normal authentication is not performed). For example, Patent Literature 1 discloses that continuity of position time information is checked to detect the abnormality. Patent Literature 2 discloses that a position of an authentication apparatus and information about a position of a target person are used together to detect the abnormality. Patent Literature 3 discloses that it is checked whether or not a movement history at a gate satisfies a predetermined condition, thereby to detect the abnormality.

As another related technique/technology, for example, Patent Literature 4 discloses that a face identification result using a feature quantity of a face image is used to detect spoofing, peeping, or the like.

### CITATION LIST

### Patent Literature

Patent Literature 1: JP2006-331048A

Patent Literature 2: JP2002-117377A

Patent Literature 3: JP2011-002918A

Patent Literature 4: JP2022-031747A

### SUMMARY

This disclosure aims to improve the techniques/technologies disclosed in Citation List.

### Solution to Problem

An information processing system according to an example aspect of this disclosure includes: an information acquisition unit that acquires authentication history information indicating a history of authentication processing of collating/verifying a target image with a registered image; an abnormality detection unit that detects an abnormality in the authentication processing, based on the authentication history information; a cause classification unit that classifies a cause of the abnormality by using the authentication history information in response to the abnormality being detected; and a cause notification unit that gives notice of the classified cause of the abnormality.

An information processing method according to an example aspect of this disclosure includes: acquiring authentication history information indicating a history of authentication processing of collating/verifying a target image with a registered image; detecting an abnormality in the authentication processing, based on the authentication history information; classifying a cause of the abnormality by using the authentication history information in response to the abnormality being detected; and giving notice of the classified cause of the abnormality.

A recording medium according to an example aspect of this disclosure is a recording medium on which a computer program that allows at least one computer to execute an information processing method is recorded, the information processing method including: acquiring authentication history information indicating a history of authentication processing of collating/verifying a target image with a registered image; detecting an abnormality in the authentication processing, based on the authentication history information; classifying a cause of the abnormality by using the authentication history information in response to the abnormality being detected; and giving notice of the classified cause of the abnormality.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of operation of the information processing system according to the first example embodiment.

FIG. 4 is a flowchart illustrating a flow of a cause classification operation by an information processing system according to a second example embodiment.

FIG. 5 is a flowchart illustrating a flow of a cause classification operation by an information processing system according to a third example embodiment.

FIG. 6 is a flowchart illustrating a flow of a cause classification operation by an information processing system according to a fourth example embodiment.

FIG. 7 is a flowchart illustrating a flow of a cause classification operation by an information processing system according to a fifth example embodiment.

FIG. 8 is a flowchart illustrating a flow of a cause classification operation by an information processing system according to a sixth example embodiment.

FIG. 9 is a flowchart illustrating a flow of operation of an information processing system according to a seventh example embodiment.

### DESCRIPTION OF EXAMPLE EMBODIMENTS

Hereinafter, an information processing system, an information processing method, and a recording medium according to example embodiments will be described with reference to the drawings.

### First Example Embodiment

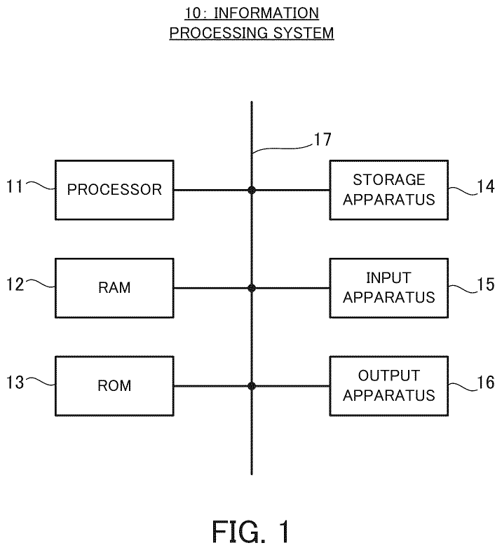

An information processing system according to a first example embodiment will be described with reference to FIG. 1 to FIG. 3.

### (Hardware Configuration)

First, with reference to FIG. 1, a hardware configuration of the information processing system according to the first example embodiment will be described. FIG. 1 is a block diagram illustrating the hardware configuration of the information processing system according to the first example embodiment.

As illustrated in FIG. 1, an information processing system 10 according to the first example embodiment includes a processor 11, a RAM (Random Access Memory) 12, a ROM (Read Only Memory) 13, and a storage apparatus 14. The information processing system 10 may further include an input apparatus 15 and an output apparatus 16. The processor 11, the RAM 12, the ROM 13, the storage apparatus 14, the input apparatus 15, and the output apparatus 16 are connected via a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium, by using a not-illustrated recording medium reading apparatus. The processor 11 may acquire (i.e., may read) a computer program from a not-illustrated apparatus disposed outside the information processing system 10, via a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for classifying and giving notice of a cause of an abnormality in authentication processing is realized or implemented in the processor 11. That is, the processor 11 may function as a controller for executing each control in the information processing system 10.

The processor 11 may be configured as, for example, a CPU (Central Processing Unit), a GPU (Graphics Processing Unit), a FPGA (Field-Programmable Gate Array), a DSP (Demand-Side Platform), or an ASIC (Application Specific Integrated Circuit). The processor 11 may be one of them, or may use a plurality of them in parallel.

The RAM 12 temporarily stores the computer program to be executed by the processor 11. The RAM 12 temporarily stores data that are temporarily used by the processor 11 when the processor 11 executes the computer program. The RAM 12 may be, for example, a D-RAM (Dynamic Random Access Memory) or a SRAM (Static Random Access Memory). Furthermore, another type of volatile memory may also be used instead of the RAM 12.

The ROM 13 stores the computer program to be executed by the processor 11. The ROM 13 may otherwise store fixed data. The ROM 13 may be, for example, a P-ROM (Programmable Read Only Memory) or an EPROM (Erasable Read Only Memory). Furthermore, another type of non-volatile memory may also be used instead of the ROM 13.

The storage apparatus 14 stores data that are stored by the information processing system 10 for a long time. The storage apparatus 14 may operate as a temporary/transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing system 10 to the outside. For example, the output apparatus 16 may be a display apparatus (e.g., a display) that is configured to display the information about the information processing system 10. The output apparatus 16 may be a speaker or the like that is configured to audio-output the information about the information processing system 10. The output apparatus 16 may be configured as a portable terminal such as a smartphone and a tablet. The output apparatus 16 may be an apparatus that outputs information in a form other than an image. For example, the output apparatus 16 may be a speaker that audio-outputs the information about the information processing system 10.

Although FIG. 1 illustrates the information processing system 10 including a plurality of apparatuses, all or a part of the functions may be realized or implemented in a single apparatus (an information processing apparatus). In such a case, the information processing apparatus may include, for example, only the processor 11, the RAM 12, and the ROM 13. The other components (i.e., the storage apparatus 14, the input apparatus 15, and the output apparatus 16) may be provided in an external apparatus connected to the information processing apparatus. In addition, in the information processing apparatus, a part of an arithmetic function may be realized by an external apparatus (e.g., an external server or cloud, etc.).

### (Functional Configuration)

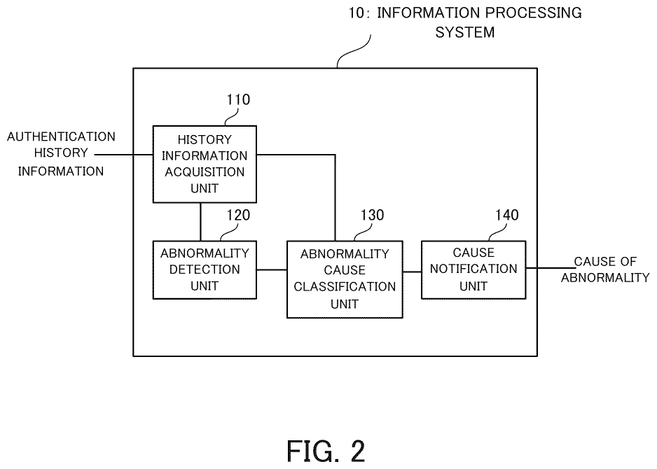

Next, with reference to FIG. 2, a functional configuration of the information processing system 10 according to the first example embodiment will be described. FIG. 2 is a block diagram illustrating the functional configuration of the information processing system according to the first example embodiment.

The information processing system 10 according to the first example embodiment is configured to classify a cause of an abnormality in authentication processing and give notice of the classified cause. In the authentication processing in the present example embodiment, a target image (i.e., an image of a target of the authentication processing) is collated/verified with a registered image (an image registered in advance). The authentication processing is not particularly limited, but may be, for example, biometric authentication of extracting biometric information from the image of the target and performing verification. Specifically, the authentication processing may be face authentication of collating/verifying a face image, or may be another authentication of collating/verifying an iris image or a fingerprint image.

As illustrated in FIG. 2, the information processing system 10 according to the first example embodiment includes, as components for realizing the functions thereof, a history information acquisition unit 110, an abnormality detection unit 120, an abnormality cause classification unit 130, and a cause notification unit 140. Each of the history information acquisition unit 110, the abnormality detection unit 120, the abnormality cause classification unit 130, and the cause notification unit 140 may be a processing block realized or implemented by the processor 11 (see FIG. 1), for example.

The history information acquisition unit 110 is configured to acquire authentication history information indicating a history of the authentication processing. The history information acquisition unit 110 may acquire the authentication history information at each time of execution of the authentication processing, or may collectively acquire accumulated pieces of authentication history information. The authentication history information may include a variety of pieces of information about the authentication processing. For example, the authentication history information may include information indicating a result of the authentication processing (i.e., a success or failure of authentication), information about an image used for the authentication processing (i.e., a target image and a registered image), information about a parameter (e.g., a matching score) and a threshold used for determination in the authentication processing, information about an authentication target, information about an authentication position or an authentication time, or the like. The authentication history information acquired by the history information acquisition unit 110 is configured to be outputted to each of the abnormality detection unit 120 and the abnormality cause classification unit 130.

The abnormality detection unit 120 is configured to detect an abnormality in the authentication processing, based on the authentication history information acquired by the history information acquisition unit 110. The “abnormality” here refers to a condition in which the authentication processing is not normally performed, and various abnormalities are expected. For example, the abnormality detection unit 120 may detect that a failure in authentication of a registered user (i.e., false rejection) as the abnormality. Alternatively, the abnormality detection unit 120 may detect a success in authentication of an unregistered user (i.e., false acceptance) as the abnormality. Alternatively, the abnormality detection unit 120 may detect that the registered user authenticated as another user, as the abnormality. Alternatively, the abnormality detection unit 120 may detect that normal authentication is not performed due to an inadequate image to be collated/verified, as the abnormality. Alternatively, the abnormality detection unit 120 may detect that the authentication target is a suspicious person, as the abnormality. A detection result by the abnormality detection unit 120 is configured to be outputted to the abnormality cause classification unit 130.

The abnormality cause classification unit 130 is configured to classify a cause of the detected abnormality when the abnormality is detected by the abnormality detection unit 120. The abnormality cause classification unit 130 classifies the cause of the abnormality in the authentication processing, by using the authentication history information acquired by the history information acquisition unit 110. The abnormality cause classification unit 130 may classify the cause of the abnormality by determining which of a plurality of classification candidates prepared in advance fits the detected abnormality. An operation of classifying the cause of the abnormality by the abnormality cause classification unit 130 will be described in detail in another example embodiment later. Information about the cause of the abnormality classified by the abnormality cause classification unit 130 is configured to be outputted to the cause notification unit 140.

The cause notification unit 140 is configured to give notice of the cause of the abnormality classified by the abnormality cause classification unit 130. The cause notification unit 140 may notify a target person of the authentication processing, an observer/monitoring person, a system manager/administrator, or the like, of the cause of the abnormality, for example. The cause notification unit 140 may give notice of the cause of the abnormality via the output apparatus 16, for example. For example, the cause notification unit 140 may display an image or a video indicating the cause of the abnormality via a display. Alternatively, the cause notification unit 140 may output a sound indicating the cause of the abnormality t via a speaker.

### (Flow of Operation)

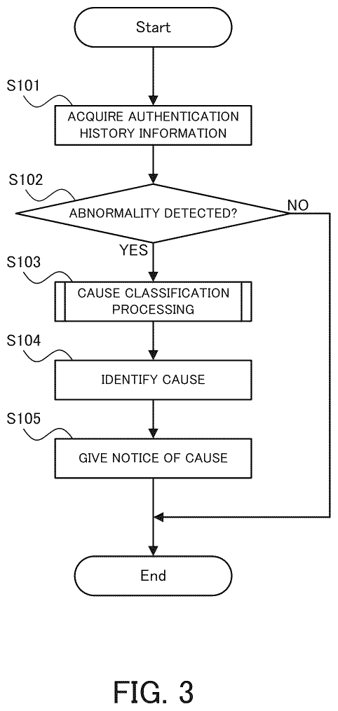

Next, with reference to FIG. 3, a flow of overall operation by the information processing system 10 according to the first example embodiment will be described. FIG. 3 is a flowchart illustrating the flow of the operation of the information processing system according to the first example embodiment.

As illustrated in FIG. 3, at the start of the operation of the information processing system 10 according to the first example embodiment, first, the history information acquisition unit 110 acquires the authentication history information (step S101). The abnormality detection unit 120 then detects the abnormality in the authentication processing, based on the authentication history information acquired by the history information acquisition unit 110 (step S102).

When no abnormality is detected (the step S102: NO), the subsequent processing will be omitted, and a series of operation steps is ended. On the other hand, when the abnormality is detected (the step S102: YES), the abnormality cause classification unit 130 performs processing of classifying the cause of the abnormality, by using the authentication history information acquired by the history information acquisition unit 110 (step S103).

The abnormality cause classification unit 130 identifies the cause of the abnormality from a processing result in the step S103 (step S104). Then, the cause notification unit 140 gives notice of the cause of the abnormality identified by the abnormality cause classification unit 130 (step S105). The cause notification unit 140 may give notice of a countermeasure for improving the cause of the abnormality, together with the cause of the abnormality.

### (Technical Effect)

Next, a technical effect obtained by the information processing system 10 according to the first example embodiment will be described.

As described in FIG. 1 to FIG. 3, in the information processing system 10 according to the first example embodiment, when the abnormality occurs in the authentication processing, the cause of the abnormality is classified, and notice of the cause of the abnormality is given. In this way, it is possible to properly give notice of a reason why the abnormality in the authentication processing occurs. Thus, it is possible to properly take a corrective action for the abnormality, for example.

### Second Example Embodiment

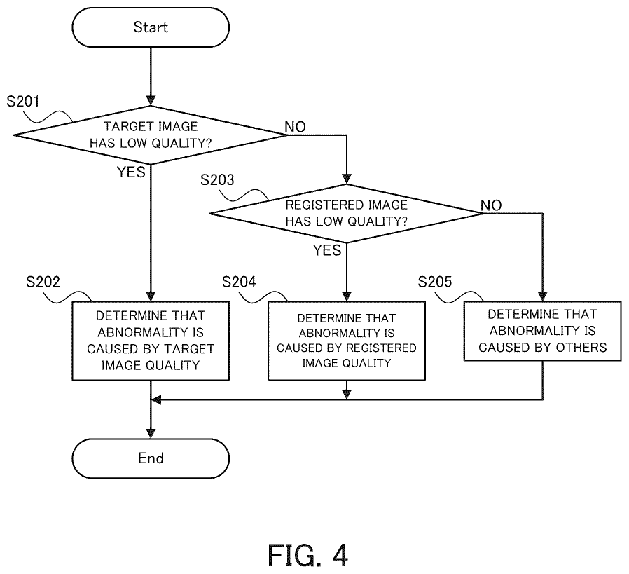

The information processing system 10 according to a second example embodiment will be described with reference to FIG. 4. The second example embodiment describes a specific example of an operation of classifying the cause of the abnormality in the first example embodiment, and may be the same as the first example embodiment in the other parts. For this reason, a part that is different from the first example embodiment will be described in detail below, and a description of the other overlapping parts will be omitted as appropriate.

### (Cause Classification Operation)

First, with reference to FIG. 4, a flow of a cause classification operation (i.e., an operation when classifying the cause of the abnormality in the authentication processing) by the information processing system 10 according to the second example embodiment will be described. FIG. 4 is a flowchart illustrating the flow of the cause classification operation by the information processing system according to the second example embodiment.

As illustrated in FIG. 4, at the start of the cause classification operation by the information processing system 10 according to the second example embodiment, the abnormality cause classification unit 130 determines whether or not the target image (i.e., the image of the target collated/verified in the authentication processing) has low the quality (step S201). The abnormality cause classification unit 130 may calculate a score indicating the quality of the target image, and may determine whether or not the score is greater than or equal to a predetermined threshold, for example. When it is determined that the target image has low quality (the step S201: YES), the abnormality cause classification unit 130 determines that the abnormality is caused by the quality of the target image (step S202). That is, the abnormality cause classification unit 130 determines that the authentication processing cannot be normally performed due to the low quality of the target image.

On the other hand, when it is not determined that the target image has low quality (the step S201: NO), the abnormality cause classification unit 130 determines whether or not the registered image (i.e., the registered image collated/verified with the target image) has low quality (step S203). The abnormality cause classification unit 130 may calculate a score indicating the quality of the registered image, and may determine whether or not the score is greater than or equal to a predetermined threshold, for example. The threshold here may have the same value as that of the threshold used in the determination of the target image (i.e., the determination in the step of S201), or may have a different value. For example, in a case where the target image is a face image, the quality of the image may be evaluated in terms of whether an entire face is visible, whether the face is hidden by hair, a hat, sunglasses, a mask, or the like, whether the number of pixels and an angle are in an acceptable range, whether it is out of focus or blurry, whether brightness and contrast are adequate, or the like.

When it is determined that the registered image has low quality (the step S203: YES), the abnormality cause classification unit 130 determines that the abnormality is caused by the quality of the registered image (step S204). That is, the abnormality cause classification unit 130 determines that authentication processing cannot be normally performed due to the low quality of the registered image.

On the other hand, when it is not determined that the registered image has low quality (the step S203: NO), the abnormality cause classification unit 130 determines that the abnormality is caused by other than the quality of the target image and the quality of the registered image (step S205). In this instance, the abnormality cause classification unit 130 may perform the processing of classifying the cause by performing another type of determination processing.

When the abnormality is caused by the quality of the target image or the quality of the registered image, the cause notification unit 140 may give notice of the countermeasure for improving the cause of the abnormality (i.e., the quality of the target image or the registered image), together with the classified cause of the abnormality. For example, the notification content of the cause notification unit 140 may include a message such as “Please capture the target image again” and “Please update the registered image”.

### (Technical Effect)

Next a technical effect obtained by the information processing system 10 according to the second example embodiment will be described.

As illustrated in FIG. 4, the information processing system 10 according to the second example embodiment performs processing of checking the quality of the target image and the registered image. In this way, it is possible to identify the low quality of the target image or the registered image, as the cause of the abnormality. Therefore, it is possible to divide the cause of the abnormality into a case where it is the quality of the image, and a case where it is not.

### Third Example Embodiment

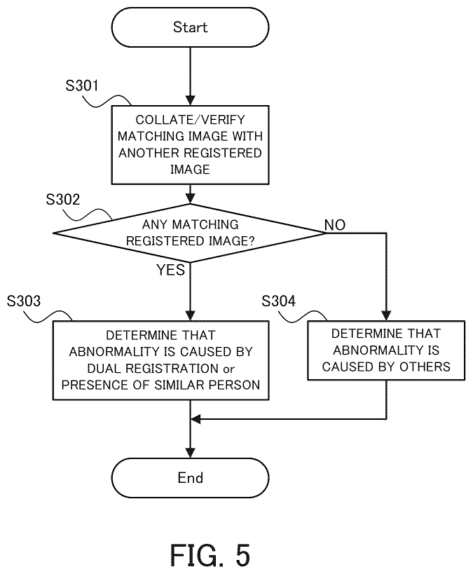

The information processing system 10 according to a third example embodiment will be described with reference to FIG. 5. The third example embodiment describes a specific example of the cause classification operation as in the second example embodiment, and may be the same as the first and second example embodiments in the other parts. For this reason, a part that is different from each of the example embodiments described above will be described in detail below, and a description of the other overlapping parts will be omitted as appropriate.

### (Cause Classification Operation)

First, with reference to FIG. 5, a flow of a cause classification operation by the information processing system 10 according to the third example embodiment will be described. FIG. 5 is a flowchart illustrating the flow of the cause classification operation by the information processing system according to the third example embodiment. It is assumed that the following processing is performed in the occurrence of an abnormality in which a user who is an authentication target is authenticated as another user.

As illustrated in FIG. 5, at the start of the cause classification operation by the information processing system 10 according to the third example embodiment, the abnormality cause classification unit 130 performs verification processing between a matching image that matches the target image in the authentication processing (i.e., an image determined to have a highest matching degree), and the other registered images (step S301). This verification processing may be 1:N matching.

Subsequently, the abnormality cause classification unit 130 determines whether there is another matching registered image that matches the matching image, as a result of the above-described verification (step S302). When it is determined that there is a matching registered image (the step S302: YES), the abnormality cause classification unit 130 determines that the abnormality is caused by dual registration or presence of a similar registered person (step S303).

Assumed as an example of the dual registration, is a situation in which an image of a user A is registered not only as the user A, but also a user B. In this case, a possible situation is that the user A is authenticated as the user B (i.e., a target image of the user A who is an authentication target, matches the image of the user A, which is registered as that of the user B).

Assumed as an example of the presence of a similar registered person, is a situation in which there is another person who cannot be easily distinguished, such as a twin. Even in this case, a possible situation is that the user A is authenticated as the user B (i.e., the target image of the user A who is an authentication target, matches a registered image of the user B who looks a lot like the user A.

On the other hand, when it is determined that there is no matching registered image (the step S302: NO), the abnormality cause classification unit 130 determines that the abnormality is caused by other than the above (step S304). In this instance, the abnormality cause classification unit 130 may perform the processing of classifying the cause by performing another type of determination processing.

In a case where the abnormality is caused by the dual registration, the cause notification unit 140 may give notice of the countermeasure for improving the cause of the abnormality (i.e., the dual registration), together with the classified cause of the abnormality. For example, the notification content of the cause notification unit 140 may include a message such as “The same image is registered in duplicate. Please register a correct image.”

### (Technical Effect)

Next a technical effect obtained by the information processing system 10 according to the third example embodiment will be described.

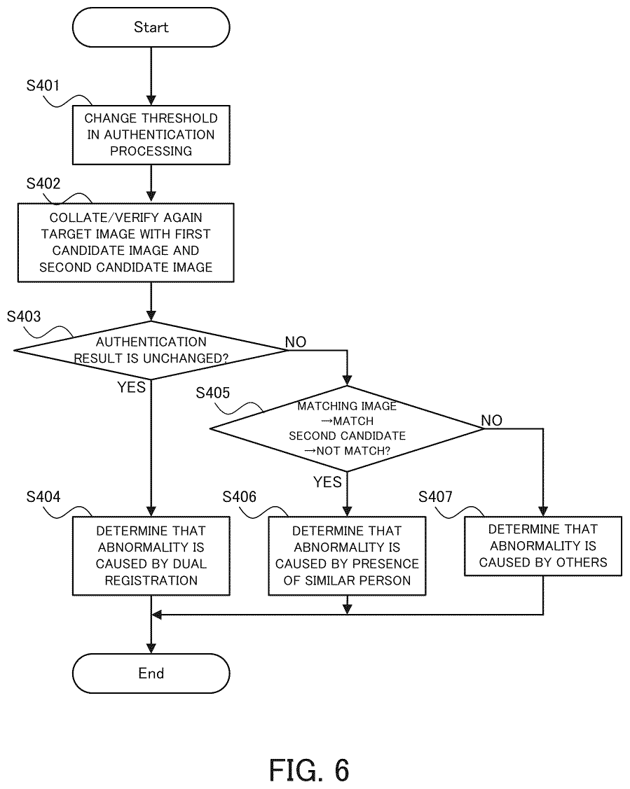

As described in FIG. 5, the information processing system 10 according to the third example embodiment performs processing of collating/verifying the matching registered image in the authentication processing with the other registered images. In this way, it is possible to identify the registration of a plurality of same or similar images, as the cause of the abnormality. The information processing system 10 according to a fourth example embodiment will be described with reference to FIG. 6. The fourth example embodiment describes a specific example of the cause classification operation as in the second and third example embodiments, and may be the same as the first to third example embodiments in the other parts. For this reason, a part that is different from each of the example embodiments described above will be described in detail below, and a description of the other overlapping parts will be omitted as appropriate.

### (Cause Classification Operation)

First, with reference to FIG. 6, a flow of a cause classification operation by the information processing system 10 according to the fourth example embodiment will be described. FIG. 6 is a flowchart illustrating the flow of the cause classification operation by the information processing system according to the fourth example embodiment. It is assumed that the following processing is performed in the occurrence of an abnormality in which the target image of the user who is an authentication target matches the registered images of two different users.

As illustrated in FIG. 6, at the start of the cause classification operation by the information processing system 10 according to the fourth example embodiment, the abnormality cause classification unit 130 changes the threshold used for the determination of a success or failure in the authentication processing (i.e., the threshold for determining whether or not the images match (step S401). The abnormality cause classification unit 130 may change the threshold such that the authentication is hardly successful, for example. More specifically, the abnormality cause classification unit 130 may change a lenient threshold that allows others to a certain extent to reduce a false rejection rate, to a strict threshold that further reduces a false acceptance rate.

Subsequently, the abnormality cause classification unit 130 performs the verification processing again with a first candidate image matching the target image (an image with the highest matching degree) and a second candidate image matching the target image (an image with the second highest matching degree), respectively, by using the changed threshold (step S402). Then, the abnormality cause classification unit 130 determines whether or not a result of the re-verification is unchanged from a first authentication result (step S403). That is, the abnormality cause classification unit 130 determines whether or not both of the first candidate image and the second candidate image continue to match the target image.

When the authentication result is unchanged (the step S403: YES), the abnormality cause classification unit 130 determines that the abnormality is caused by the dual registration (i.e., the same image is registered in duplicate) (step S404). This is because in a case where the first candidate image and the second candidate image are the same, it is considered that there is no change in the authentication result even if the threshold used for the authentication is changed.

On the other hand, when the authentication result is changed (the step S403: NO), the abnormality cause classification unit 130 determines whether or not the first candidate image matches the target image and the second candidate image does not (step S405). When it is determined that the first candidate image matches the target image and the second candidate image does not (the step S405: YES), the abnormality cause classification unit 130 determines that the abnormality is caused by the presence of a similar person (step S406). This is because it is considered to be determined that only the image of a person in question (i.e., the first candidate image) matches the target image and the image of a similar person (i.e., the second candidate image) does not, by setting a strict threshold.

On the other hand, when it is not determined that the first candidate image matches the target image and the second candidate image does not match (the step S405: NO), the abnormality cause classification unit 130 determines that the abnormality is caused by other than the above (step S304). In this instance, the abnormality cause classification unit 130 may perform the processing of classifying the cause by performing another type of determination processing.

### (Technical Effect)

Next a technical effect obtained by the information processing system 10 according to the fourth example embodiment will be described.

As described in FIG. 6, the information processing system 10 according to the fourth example embodiment performs processing of changing the threshold used in the authentication processing and performing the verification again. By changing the ease of the authentication and performing the authentication again, it is possible to understand, from the authentication result, whether the abnormality is caused by the dual registration or the presence of a similar person.

### Fifth Example Embodiment

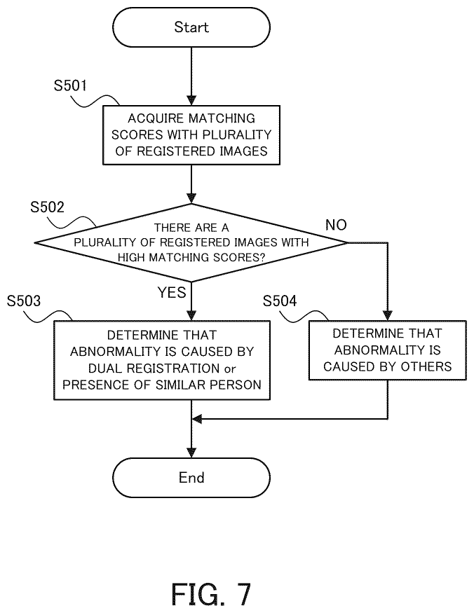

The information processing system 10 according to a fifth example embodiment will be described with reference to FIG. 7. The fifth example embodiment describes a specific example of the cause classification operation as in the second to fourth example embodiments, and may be the same as the first to fourth example embodiments in the other parts. For this reason, a part that is different from each of the example embodiments described above will be described in detail below, and a description of the other overlapping parts will be omitted as appropriate.

### (cause Classification Operation)

First, with reference to FIG. 7, a flow of a cause classification operation by the information processing system 10 according to the fifth example embodiment will be described. FIG. 7 is a flowchart illustrating the flow of the cause classification operation by the information processing system according to the fifth example embodiment. It is assumed that the following processing is performed in the occurrence of an abnormality in which a user who is an authentication target is authenticated as another user.

As illustrated in FIG. 7, at the start of the cause classification operation by the information processing system 10 according to the fifth example embodiment, the abnormality cause classification unit 130 acquires a matching score (i.e., a score indicating a matching degree) between the target image and a plurality of registered images (step S501). That is, the abnormality cause classification unit 130 acquires a plurality of matching scores calculated for the plurality of respective registered images, in the authentication processing (1:N matching).

Subsequently, the abnormality cause classification unit 130 determines whether or not there are a plurality of registered images with high matching scores, among the plurality of registered images (step S502). For example, the abnormality cause classification unit 130 determines whether or not there are a plurality of authentication scores exceeding a predetermined threshold. The threshold here may be the same as the threshold used for the authentication processing, or may have a different value.

When it is determined that there are a plurality of registered images with high matching scores (the step S502: YES), the abnormality cause classification unit 130 determines that the abnormality is caused by the dual registration or the presence of a similar registered person (step S503). This is because, in a case where a plurality of same images and similar images are registered, high matching scores are considered to be calculated for the plurality of registered images.

On the other hand, when it is determined that there are a plurality of registered images with high matching scores (the step S502: NO), the abnormality cause classification unit 130 determines that the abnormality is caused by other than the above (step S504). In this instance, the abnormality cause classification unit 130 may perform the processing of classifying the cause by performing another type of determination processing.

### (Technical Effect)

Next a technical effect obtained by the information processing system 10 according to the fifth example embodiment will be described.

As described in FIG. 7, in the information processing system 10 according to the fifth example embodiment, the matching scores with the plurality of registered images are acquired. In this way, it is possible to identify the cause of the anomaly by comparing and analyzing the plurality of matching scores.

### sixth Example Embodiment

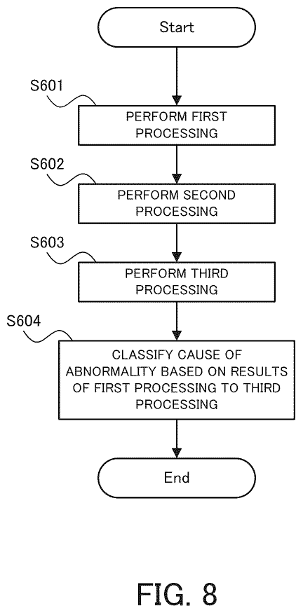

The information processing system 10 according to a sixth example embodiment will be described with reference to FIG. 8. The information processing system 10 according to the sixth example embodiment describes a specific example of the cause classification operation as in the second to fifth example embodiments, and may be the same as the first to fifth example embodiments in the other parts. For this reason, a part that is different from each of the example embodiments described above will be described in detail below, and a description of the other overlapping parts will be omitted as appropriate.

### (Cause Classification Operation)

First, with reference to FIG. 8, a flow of a cause classification operation by the information processing system 10 according to the sixth example embodiment will be described. FIG. 8 is a flowchart illustrating the flow of the cause classification operation by the information processing system according to the sixth example embodiment.

As illustrated in FIG. 8, at the start of the cause classification operation by the information processing system 10 according to the sixth example embodiment, the abnormality cause classification unit 130 performs first processing (step S601). The first processing here is processing of checking the quality of the target image and the registered image, described in the second example embodiment (see FIG. 4).

Subsequently, the abnormality cause classification unit 130 performs second processing (step S602). The second processing here is the processing of collating/verifying the matching registered image in the authentication processing with the other registered images, described in the third example embodiment (see FIG. 5).

Subsequently, the abnormality cause classification unit 130 performs third processing (step S603). The third processing here is the processing of changing the threshold used in the authentication processing and performing the verification again, described in the fourth example embodiment (see FIG. 6).

Finally, the abnormality cause classification unit 130 classifies the cause of the anomaly, based on results of the first processing, the second processing, and the third processing (step S604). For example, from the result of the first processing, it is possible to classify the anomality caused by the quality of the target image or the registered image. From the result of the second processing, it is possible to classify the anomality caused by the dual registration or the presence of a similar registered person. From the result of the third processing, it is possible to separate the anomality caused by the dual registration, and the anomality caused by the presence of a similar registered person.

Exemplified here is performing each processing in the order of the first processing, the second processing, and the third processing; however, the order of performing each processing is not particularly limited. For example, the first processing, the second processing, and the third processing may be performed before and after each other, or may be performed in parallel simultaneously.

### (Technical Effect)

Next a technical effect obtained by the information processing system 10 according to the sixth example embodiment will be described.

As illustrated in FIG. 8, in the information processing system 10 according to the sixth example embodiment, the cause of the abnormality is classified based on the results of the plurality of types of processing. In this way, since the plurality of results are considered, it is possible to classify the cause of the anomaly, more precisely and in more detail, for example, in comparison with a case where the cause of the anomaly is classified by using only one type of processing. For example, the second processing alone has difficulty in determining whether the abnormality is caused by the dual registration or the presence of a similar person, but additional combination of the third processing makes it possible to separate those causes.

Exemplified in the above example embodiment is respectively performing the first processing, the second processing, and the third processing. In addition to these types of processing, processing of analyzing the matching scores with the plurality of registered images (fourth processing), described in the fifth example embodiment, may be performed.

Furthermore, each of the first processing to the fourth processing may be combined and performed as appropriate. That is, at least two types of processing may be selected from the first processing to the fourth processing, and may be combined and performed to classify the cause of the abnormality. For example, the first processing and the second processing may be combined and performed, or the second processing and the third processing may be combined and performed.

In addition to the first processing to the fourth processing, another type of processing may be performed. An example of another type of processing may include processing of performing liveness determination (spoofing determination) or the like, for example. By performing such processing, it is possible to classify the presence of a suspicious person attempting to unauthorizedly/illegally break through the authentication, as the cause of the anomality, for example.

### Seventh Example Embodiment

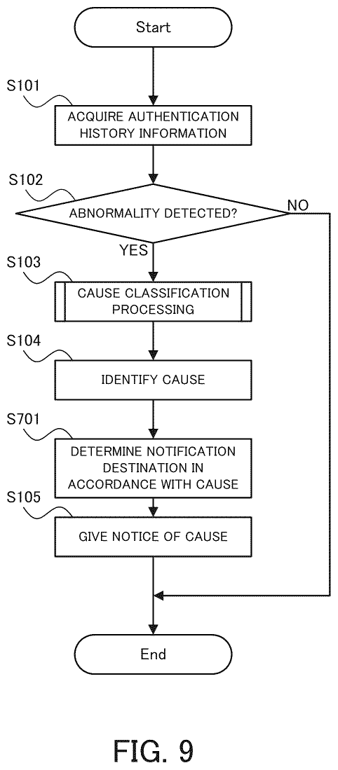

The information processing system 10 according to a seventh example embodiment will be described with reference to FIG. 9. The information processing system 10 according to the seventh example embodiment is partially different from the first to sixth example embodiments only in the operation, and may be the same as the first to sixth example embodiments in the other parts. For this reason, a part that is different from each of the example embodiments described above will be described in detail below, and a description of the other overlapping parts will be omitted as appropriate.

### (Flow of Operation)

First, with reference to FIG. 9, a flow of overall operation by the information processing system 10 according to the seventh example embodiment will be described. FIG. 9 is a flowchart illustrating the flow of the operation of the information processing system according to the seventh example embodiment. In FIG. 9, the same processing steps as those illustrated in FIG. 3 carry the same reference numerals.

As illustrated in FIG. 9, at the start of the operation of the information processing system 10 according to the seventh example embodiment, first, the history information acquisition unit 110 acquires the authentication history information (step S101). The abnormality detection unit 120 then detects the abnormality in the authentication processing, based on the authentication history information acquired by the history information acquisition unit 110 (step S102).

When no abnormality is detected (the step S102: NO), the subsequent processing will be omitted, and a series of operation steps is ended. On the other hand, when the abnormality is detected (the step S102: YES), the abnormality cause classification unit 130 performs processing of classifying the cause of the abnormality, by using the authentication history information acquired by the history information acquisition unit 110 (step S103).

The abnormality cause classification unit 130 identifies the cause of the abnormality from a processing result in the step S103 (step S104). Especially in the present example embodiment, the cause notification unit 140 determines a notification destination of the cause of the abnormality, in accordance with the cause of the abnormality identified by the abnormality cause classification unit 130 (step S701). Thereafter, the cause notification unit 140 gives notice of the cause of the abnormality, to the notification destination (step S105).

For example, when the abnormality is caused by the quality of the target image or the registered image, the cause notification unit 140 may notify a target person of the authentication processing, of the cause of the abnormality. Alternatively, when the abnormality is caused by the dual registration or the presence of a similar person, the cause notification unit 140 may notify a system manager/administrator of the cause of the abnormality. Alternatively, when the abnormality is caused by a suspicious person, the cause notification unit 140 may notify an observer/monitoring person of the cause of the abnormality.

The cause notification unit 140 may also change a notification aspect depending on the cause of the abnormality. For example, for a highly urgent cause of the abnormality, the notification may be made in a conspicuous display aspect (e.g., in conspicuous color or by large characters, etc.) or by a loud sound. For the highly urgent cause of the abnormality, notification timing may be set to be as early as possible. On the other hand, for a less urgent cause of the abnormality, the notification timing may be set to be slightly slower (e.g., the notification may be made collectively later).

### (Technical Effect)

Next a technical effect obtained by the information processing system 10 according to the seventh example embodiment will be described.

As described in FIG. 9, in the information processing system 10 according to the seventh example embodiment, the notification destination is determined according to the classified cause of the abnormality. In this way, it is possible to properly notify a person to be notified, of the cause of the abnormality in the authentication processing. Thus, it is possible to properly take a corrective action for the abnormality, for example.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to

### Supplementary Notes

The example embodiments described above may be further described as, but not limited to, the following Supplementary Notes below.

(supplementary Note 1)

An information processing system according to Supplementary Note 1 is an information processing system including: an information acquisition unit that acquires authentication history information indicating a history of authentication processing of collating/verifying a target image with a registered image; an abnormality detection unit that detects an abnormality in the authentication processing, based on the authentication history information; a cause classification unit that classifies a cause of the abnormality by using the authentication history information in response to the abnormality being detected; and a cause notification unit that gives notice of the classified cause of the abnormality.

(supplementary Note 2)

An information processing system according to Supplementary Note 2 is the information processing system according to Supplementary Note 1, wherein the cause classification unit performs first processing of determining whether or not quality of at least one of the target image and the registered image is greater than or equal to predetermined quality, and classifies the cause of the abnormality, based on a result of the first processing.

(supplementary Note 3)

An information processing system according to Supplementary Note 3 is the information processing system according to Supplementary Note 1 or 2, wherein the cause classification unit performs second processing of collating/verifying a matching image that is the registration image matching the target image in the authentication processing, with a non-matching image that is the registered image not matching the target image, and classifies the cause of the abnormality, based on a result of the second processing.

### (Supplementary Note 4)

An information processing system according to Supplementary Note 4 is the information processing system according to any one of Supplementary Notes 1 to 3, wherein the cause classification unit performs third processing of collating/verifying again the target image with the registered image by using a second threshold that is greater than the first threshold used in the authentication processing, and classifies the cause of the abnormality, based on a result of the third processing.

(Supplementary Note 5)

An information processing system according to Supplementary Note 5 is the information processing system according to any one of Supplementary Notes 1 to 4, wherein the cause classification unit performs fourth processing of acquiring a plurality of matching scores each indicating a matching degree between the target image and respective one of a plurality of registered images, and classifies the cause of the abnormality, based on the plurality of matching scores.

### (Supplementary Note 6)

An information processing system according to Supplementary Note 6 is the information processing system according to any one of Supplementary Notes 1 to 5, wherein the cause classification unit performs: (i) first processing of determining whether or not quality of at least one of the target image and the registered image is greater than or equal to predetermined quality; (ii) second processing of collating/verifying a matching image that is the registration image matching the target image, with a non-matching image that is the registered image not matching the target image; and (iii) third processing of collating/verifying again the target image with the registered image by using a second threshold that is greater than the first threshold used in the authentication processing, and classifies the cause of the abnormality, based on results of the first processing, the second processing, and the third processing.

### (Supplementary Note 7)

An information processing system according to Supplementary Note 7 is the information processing system according to any one of Supplementary Notes 1 to 6, wherein the cause notification unit changes a notification destination depending on the cause of the abnormality.

### (Supplementary Note 8)

An information processing method according to Supplementary Note 7 is an information processing method that is executed by at least one computer, the information processing method including: acquiring authentication history information indicating a history of authentication processing of collating/verifying a target image with a registered image; detecting an abnormality in the authentication processing, based on the authentication history information; classifying a cause of the abnormality by using the authentication history information in response to the abnormality being detected; and giving notice of the classified cause of the abnormality.

(Supplementary Note 9)

A recording medium according to Supplementary Note 9 is a recording medium on which a computer program that allows at least one computer to execute an information processing method is recorded, the information processing method including: acquiring authentication history information indicating a history of authentication processing of collating/verifying a target image with a registered image; detecting an abnormality in the authentication processing, based on the authentication history information; classifying a cause of the abnormality by using the authentication history information in response to the abnormality being detected; and giving notice of the classified cause of the abnormality.

(Supplementary Note 10)

A computer program according to Supplementary Note 10 is a computer program that allows at least one computer to execute an information processing method, the information processing method including: acquiring authentication history information indicating a history of authentication processing of collating/verifying a target image with a registered image; detecting an abnormality in the authentication processing, based on the authentication history information; classifying a cause of the abnormality by using the authentication history information in response to the abnormality being detected; and giving notice of the classified cause of the abnormality.

### (Supplementary Note 11)

An information processing apparatus according to Supplementary Note 11 is an information processing apparatus including: an information acquisition unit that acquires authentication history information indicating a history of authentication processing of collating/verifying a target image with a registered image; an abnormality detection unit that detects an abnormality in the authentication processing, based on the authentication history information; a cause classification unit that classifies a cause of the abnormality by using the authentication history information in response to the abnormality being detected; and a cause notification unit that gives notice of the classified cause of the abnormality.

This disclosure is allowed to be changed, if desired, without departing from the essence or spirit of this disclosure which can be read from the claims and the entire specification. An information processing system, an information processing method, and a recording medium with such changes are also intended to be within the technical scope of this disclosure.

### DESCRIPTION OF REFERENCE CODES

10 Information processing system
11 Processor
110 History information acquisition unit
120 Abnormality detection unit
130 Abnormality cause classification unit
140 Cause notification unit

What is claimed is:

1. An information processing system comprising:
at least one memory that is configured to store instructions; and
at least one processor that is configured to execute the instructions to:
acquire authentication history information indicating a history of authentication processing of collating/verifying a target image with a registered image;
detect an abnormality in the authentication processing, based on the authentication history information;
classify a cause of the abnormality by using the authentication history information in response to the abnormality being detected; and
a give notice of the classified cause of the abnormality.

2. The information processing system according to claim 1, wherein the at least one processor that is configured to execute the instructions to perform the first processing of determining whether or not quality of at least one of the target image and the registered image is greater than or equal to predetermined quality, and classify the cause of the abnormality, based on a result of the first processing.

3. The information processing system according to claim 1, wherein the at least one processor that is configured to execute the instructions to perform processing of collating/verifying a matching image that is the registration image matching the target image in the authentication processing, with a non-matching image that is the registered image not matching the target image, and classify the cause of the abnormality, based on a result of the second processing.

4. The information processing system according to claim 1, wherein the at least one processor that is configured to execute the instructions to perform the cause classification unit performs third processing of collating/verifying again the target image with the registered image by using a second threshold that is greater than the first threshold used in the authentication processing, and classify the cause of the abnormality, based on a result of the third processing.

5. The information processing system according to claim 1, wherein the at least one processor that is configured to execute the instructions to perform processing of acquiring a plurality of matching scores each indicating a matching degree between the target image and respective one of a plurality of registered images, and classifies classify the cause of the abnormality, based on the plurality of matching scores.

6. The information processing system according to claim 1, wherein the at least one processor that is configured to execute the instructions to perform: first processing of determining whether or not quality of at least one of the target image and the registered image is greater than or equal to predetermined quality; (ii) second processing of collating/verifying a matching image that is the registration image matching the target image, with a non-matching image that is the registered image not matching the target image; and (iii) third processing of collating/verifying again the target image with the registered image by using a second threshold that is greater than the first threshold used in the authentication processing, and classify the cause of the abnormality, based on results of the first processing, the second processing, and the third processing.

7. The information processing system according to claim 1, wherein the at least one processor that is configured to execute the instructions to change notification destination depending on the cause of the abnormality.

8. An information processing method that is executed by at least one computer, the information processing method comprising:
acquiring authentication history information indicating a history of authentication processing of collating/verifying a target image with a registered image;
detecting an abnormality in the authentication processing, based on the authentication history information;
classifying a cause of the abnormality by using the authentication history information in response to the abnormality being detected; and
giving notice of the classified cause of the abnormality.

9. A non-transitory_recording medium on which a computer program that allows at least one computer to execute an information processing method is recorded, the information processing method including:
acquiring authentication history information indicating a history of authentication processing of collating/verifying a target image with a registered image;
detecting an abnormality in the authentication processing, based on the authentication history information;
classifying a cause of the abnormality by using the authentication history information in response to the abnormality being detected; and
giving notice of the classified cause of the abnormality.
